(19) United States
(12) Patent Application Publication
(10) Pub. No.: US 2022/0259081 A1
(43) Pub. Date: Aug. 18, 2022

(54) ELECTROCHEMICAL SOIL TREATMENT APPARATUS AND METHOD

(71) Applicants: Mehrooz ZAMANZADEH, Pittsburgh, PA (US); Carolyn TOME, Pittsburgh, PA (US); Peyman TAHERI BONAB, Vancouver (CA); MATERGENICS. INC., Pittsburgh, PA (US)

(72) Inventors: Mehrooz Zamanzadeh, Pittsburgh, PA (US); Peyman Taheri Bonab, Vancouver, BC (CA); Carolyn Tome, Pittsburgh, PA (US)

(21) Appl. No.: 17/625,332

(22) PCT Filed: Jul. 7, 2020
(86) PCT No.: PCT/US20/40952

§ 371 Date: Jan. 6, 2022

Related U.S. Application Data
(60) Provisional application No. 62/871,214, filed on Jul. 8, 2019.

(51) Int. Cl. C02F 1/461

(52) U.S. Cl. CPC C02F 1/46109; C02F 2101/105; C02F 2001/46133

(57) ABSTRACT

An electrochemical cell has a high-performance alloy cathode, an oxidation resistant anode, an electrolyte, and a power supply. The electrolyte is contained within growth media containing an aqueous solution and a plurality of transport ions therein. The high-performance alloy cathode and the oxidation resistant anode are submerged in the growth media at least partially. The power supply provides power to the oxidation resistant anode to attract the plurality of transport ions to treat the growth media.

### CROSS REFERENCE TO RELATED APPLICATION

This application claims the benefit under 35 U.S.C. § 119(e) of co-pending U.S. Provisional Application No. 62/871,214 entitled “ELECTROCHEMICAL SOIL TREATMENT APPARATUS AND METHOD” filed Jul. 8, 2019, which is incorporated herein by reference.

### TECHNICAL FIELD

The subject disclosure is directed to systems, methods, and apparatus for treating soil and other growth media electrochemically and, more particularly, to an electrochemical treatment system that utilizes an anode that is made from an oxidation resistant material and a cathode that is made from a high-performance alloy.

### BACKGROUND ART

Electrochemistry and the movement of ions can play various roles in agriculture. For example, the accumulation of certain soluble salt ions, such as chloride ions, can cause adverse and long lasting environmental problems with soil and ground water resources because chloride is highly soluble, does not adsorb onto soil particles, does not degrade, and generally inhibits biological processes, particularly processes involving essential oils.

Chlorides and chloride ion contamination can adversely affect soil structure and permeability. In some instances, the presence of chloride ions can inhibit seed germination]. Chloride contaminated soil can lose the ability to support agricultural crops, native grasses, or other vegetation. In some cases, this can result in soil erosion. Accordingly, there is a need for a more efficient method for removing salts and chlorine ions from soil and other growth media.

Phosphate and nitrate content are other factors that can affect agriculture, so that phosphates and nitrates can be key components in fertilizers. One class of phosphates, rock phosphates, is considered to be a non-renewable resource and is expected to become scarce in the future. Additionally, nitrates are natural constituents of plant material that are present in high levels of many types of plants, such as green vegetables. However, nitrates can accumulate in tissues, so that nitrate from fertilizers could accumulate in vegetables during large-scale farming operations.

Moreover, high input levels of phosphates in agriculture have been identified as a source of environmental problems. Excess phosphates damage agricultural environments by causing excessive algae growth and degraded water quality in nearby bodies of water. Nitrates, at elevated levels, can have harmful effects on humans, animals, and crops. Nitrates can contaminate fields, lakes, streams, septic systems, animal feed lots, industrial waste waters, sanitary landfills, and garbage dumps. Accordingly, there is a need to find ways to utilize phosphates and nitrates in agriculture more efficiently.

Landfills are sources of groundwater and soil pollution due to the production of leachate and its migration through refuse. Excessive concentrations of sulfates, nitrates, phosphates, nitrites, and heavy metals can be found within groundwater that is in close proximity to landfills.

Heavy metals constitute an ill-defined group of inorganic chemical hazards. The most commonly identified heavy metal contaminants include lead, chromium, arsenic, zinc, cadmium, copper, mercury, and nickel. Such heavy metal contaminants, unlike organic contaminants which are oxidized to carbon oxides by microbial action, do not undergo microbial or chemical degradation. As a result, their total concentration in soils persists for a long time after their introduction. Accordingly, there is a need for an efficient system to remediate soil that includes contaminants, such as chlorides, phosphates, nitrates, heavy metal, and other contaminants that result from landfills, from soil.

### DISCLOSURE OF INVENTION

In various implementations, an electrochemical treatment system includes an electrochemical cell, the electrochemical cell having a high-performance alloy cathode, an oxidation resistant anode, an electrolyte, and a DC power supply. The electrolyte is contained within growth media containing an aqueous solution and a plurality of transport ions therein. The high-performance alloy cathode and the oxidation resistant anode are submerged in the growth media at least partially, and electrically connected through the DC power source. The power supply provides power to the oxidation resistant anode to attract the plurality of transport ions to treat the growth media.

### BRIEF DESCRIPTION OF THE DRAWINGS

FIG. 1 is a fragmentary side view in cross section of an electrochemical soil treatment system in accordance with the subject matter of this disclosure.

FIG. 2 is a fragmentary side view in cross section of another embodiment of an electrochemical soil treatment system in accordance with the subject matter of this disclosure.

FIG. 3 is a fragmentary side view in cross section of another embodiment of an electrochemical soil treatment system in accordance with the subject matter of this disclosure.

FIG. 4 is a fragmentary side view in cross section of another embodiment of an electrochemical soil treatment system in accordance with the subject matter of this disclosure.

FIG. 5 is an exemplary process in accordance with the subject disclosure.

### MODES FOR CARRYING OUT THE INVENTION

The subject disclosure is directed to systems, methods, and apparatus for treating soil and other growth media electrochemically and, more particularly, to an electrochemical treatment system that utilizes an anode that is made from an oxidation resistant material and a cathode that is made from a high-performance alloy. The anode and the cathode can be inserted into the growth media, at least partially, and power can be supplied to create a potential difference to move ions through the growth media.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The subject electrochemical treatment system can be used to move salt ions and, in particular, chlorine ions, within soil or other growth media. In other applications, the electrochemical treatment system can be used to drive the movement of phosphates and/or nitrates in the presence of electric fields in order to utilize fertilizers in a more efficient manner. In yet other applications, the electrochemical treatment system can be used as part of a process for remediating contaminants, such as heavy metal ions, that result from the placement of landfill material in soil or other growth media. Additionally, the electrochemical treatment system can be used to transport water from lower elevations to higher elevations (i.e., in the opposite direction of gravity).

Soil and growth media can be understood to be natural or artificial mixtures of organic matters, minerals, gases, liquids, and/or organisms that support life. Soil can function as a medium for plant growth, as a means of water storage, supply and purification, as a modifier of adjacent atmosphere, and as a habitat for organisms and micro-organisms. In this disclosure, the primary function of soil and/or growth media is to serve as a medium for plant growth in agricultural applications.

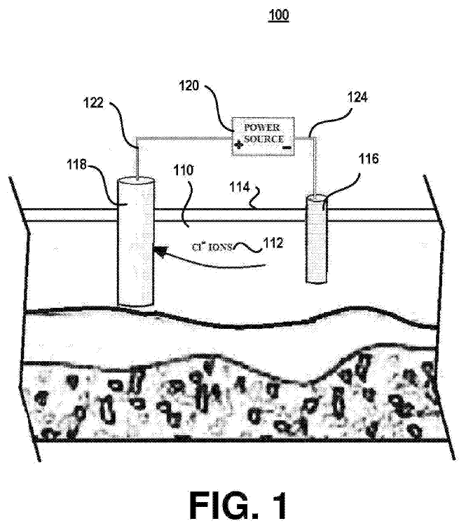

Referring now to FIG. 1, there is shown an electrochemical treatment system, generally designated by the numeral 100, for treating soil and/or other growth media, generally designated by the numeral 110. The system 100 is particularly adapted for removing chlorides, specifically chlorine ion transport ions 112, from the soil 110 over a large growing surface area 114. The system 100 can be provided in an assembled form or as a kit for assembly.

Chlorides can include various compounds or substances that can be present in the soil 110 or that can contaminate the soil 110 from groundwater, nearby drilling muds, or hydro-fracturing operations. The most common chlorides include sodium chloride, calcium chloride, magnesium chloride, ammonium chloride, potassium chloride, and barium chloride.

The decontamination of the soil 110 can be accomplished because the chlorides can naturally breakdown into pairs of cations and anions with the anions forming chlorine ion transport ions 112.

The system 100 is essentially an electrochemical cell having a high-performance alloy cathode 116, an oxidation resistant anode 118, and a DC power supply 120. The soil 110 includes an aqueous component that includes an electrolyte to complete the electrochemical cell. The high-performance alloy cathode 116 and the oxidation resistant anode 118 can be inserted into the soil 110 and submerged therein, at least partially. the power supply 120 provides power to the oxidation resistant anode 118 to attract the chlorine ions 112 to treat the soil 110.

In some embodiments, the electrolyte between the cathode 116 and the anode 118 is salt water. In such embodiments, there is an electric potential between the cathode 116 and the anode 118. Since salt water is very conductive, the potential drops occur in immediate vicinity of the cathode 116 and the anode 118. However, the electric field that interacts with chlorine ions 112 that are further away from the cathode 116 and the anode 118 is very small.

As the electrolyte becomes more resistive, the potential difference across the electrolyte drops, while, simultaneously, the chloride ions 112 that are surrounded by sodium ions (not shown) and other chloride ions (not shown), each of which exerts its own local fields, shield the chloride ions 112 from the electric field from the cathode 116 and the anode 118. Away from the immediate vicinity of the cathode 116 and the anode 118, the chloride ions 112 (as well as other ions) will move via diffusion.

If a current is flowing between the cathode 116 and the anode 118, there is a net movement of chloride ions 112 (as well as other ions) toward the anode 118. Simultaneously, there is a net movement of cations (not shown) toward the cathode 116. Soil remediation results from a slow net movement of chloride ions 112 out of the soil, in part controlled by diffusion in the bulk and potentials near the cathode 116 and the anode 118.

The power supply 120 shall be a DC power supply, such as a battery. The high-performance alloy cathode 116 and the oxidation resistant anode 118 connect to leads 122-124 extending from the power supply 120. The high-performance alloy cathode 116, the oxidation resistant anode 118, and the power supply 120 can be arranged to generate a current that is sufficient using the maximum allowable voltage that is allowed without special permits or processing to move the chlorine ions 112 within the soil 110 to their desired location.

In some embodiments, the power supply 120 can provide sufficient power to the oxidation resistant anode 118 to separate the chlorides within the soil 110 into a plurality of chlorine ions 112. The oxidation resistant anode 118 can attract the chlorine ions 112 to extract the chlorides from the soil 110. The removal of the chlorine ions 112 can change the pH of the soil 110.

The high-performance alloy cathode 116 can include one or more high-performance alloys. High-performance alloys can include iron, iron alloys, nickel and nickel alloys. Suitable iron alloys include cast irons, gray irons, white irons, ductile irons, malleable irons, wrought iron, steels, crucible steels, carbon steels, spring steels, alloy steels, maraging steels, stainless steels, weathering steels, tool steels, and other specialty steels. Suitable nickel alloys include chromel, ferronickel, hastelloys, inconels, monels, nichrome, and nickel-carbon alloys.

The oxidation resistant anode 118 can include one or more oxidation resistant materials. Oxidation resistant materials can include various forms of carbon, noble metals, and noble metal alloys. Suitable forms of carbon can include graphite, carbon nanotubes, graphene, carbon black, activated carbon, and fullerenes. Such exemplary forms of conductive carbon include single walled carbon nanotubes, multiwalled carbon nanotubes, carbon blacks of various surface areas, and other related materials. Suitable noble metals and noble metal alloys can include gold, platinum, silver, palladium, iridium, rhodium, and ruthenium or alloys of gold, platinum, silver, palladium, iridium, rhodium, or ruthenium. Noble metals can include metals that have filled electronic d-bands.

The aqueous component of the soil 110 can be any suitable aqueous solution. The aqueous solution can be an alkaline solution, an acid solution, or another water-based solution. Other suitable aqueous solutions can include potable water and low conductivity water.

The geometric configuration of the electrochemical cell is not critical. The high-performance alloy cathode 116 and the oxidation resistant anode 118 can have any suitable geometric configuration. The high-performance alloy cathode 116, the oxidation resistant anode 118, and the leads 122-124 can be in the form of mesh, foil, an ingot, sheet or wire. The leads 122-124 can be flexible, semi-rigid, or rigid members with sufficient insulation to prevent them from becoming part of the electrode to which they are attached.

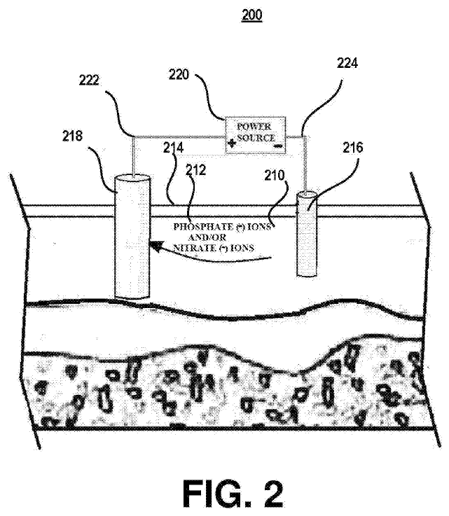

Referring now to FIG. 2 with continuing reference to the foregoing figure, there is shown another embodiment of an electrochemical treatment system, generally designated by the numeral 200, for treating soil and/or other growth media, generally designated by the numeral 210. The system 200 is particularly adapted for controlling the phosphate and/or nitrogen content of the soil 210.

The phosphate and/or nitrogen content of the soil 210 is an important factor in agriculture because phosphorus and nitrogen are key nutrients that plants need and can be limiting factors in crop yields. In particular, phosphates and nitrates can be an important component of fertilizer because maintaining the proper levels of phosphorous and nitrogen in the plants provides such plants with the ability to acquire energy, to store energy, and to transfer the energy throughout the plants. Phosphorous and nitrogen also promote the development of roots, flowers and fruit, especially essential for showy ornamental plants or for vegetables grown for consumption.

The system 200 is particularly adapted for moving transport ions in the form of phosphate ions and/or nitrate ions 212, in the soil 210 to regions that require fertilization. The regions can include a large growing surface area 214.

Like the embodiment shown in FIG. 1, the system 200 includes a high-performance alloy cathode 216, an oxidation resistant anode 218, a power supply 220, and a pair of leads 222-224. The high-performance alloy cathode 216, the oxidation resistant anode 218, the power supply 220, and the pair of leads 222-224 function in the same manner as the high-performance alloy cathode 116, the oxidation resistant anode 118, the power supply 120, and the pair of leads 122-124 shown in FIG. 1. The system 200 can be provided in an assembled form or as a kit for assembly.

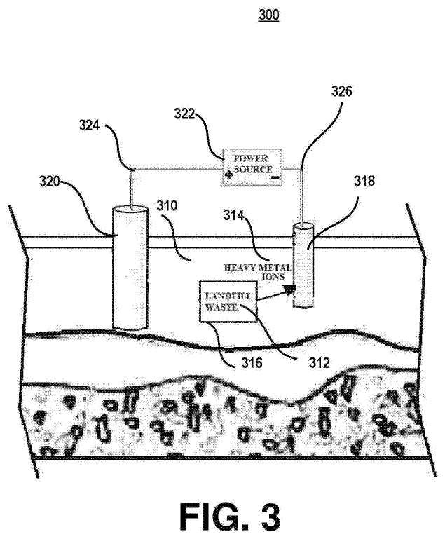

Referring now to FIG. 3 with continuing reference to the foregoing figures, there is shown another embodiment of an electrochemical treatment system, generally designated by the numeral 300, for treating soil and/or other growth media, generally designated by the numeral 310. The soil 310 surrounds landfill material 312 that includes contaminants 314.

The contaminants 314 can include sulfates, nitrates, phosphates, nitrites, and heavy metals. In some instances, the contaminants 314 will leach out of the landfill material 312. In other instances, the landfill material 312 can include a surrounding cover 316 that can become damaged, so that the contaminants 314 can contaminate groundwater or other aqueous components of the soil 310. The system 100 is particularly adapted for removing transport ions from the contaminants 314.

Like the embodiments shown in FIGS. 1-2, the system 300 includes a high-performance alloy cathode 318, an oxidation resistant anode 320, a power supply 322, and a pair of leads 324-326. The high-performance alloy cathode 318, the oxidation resistant anode 320, the power supply 322, and the pair of leads 324-326 function in the same manner as the high-performance alloy cathode 116, the oxidation resistant anode 118, the power supply 120, and the pair of leads 122-124 shown in FIG. 1 and/or the high-performance alloy cathode 216, the oxidation resistant anode 218, the power supply 220, and the pair of leads 222-224 shown in FIG. 2. The system 300 can be provided in an assembled form or as a kit for assembly.

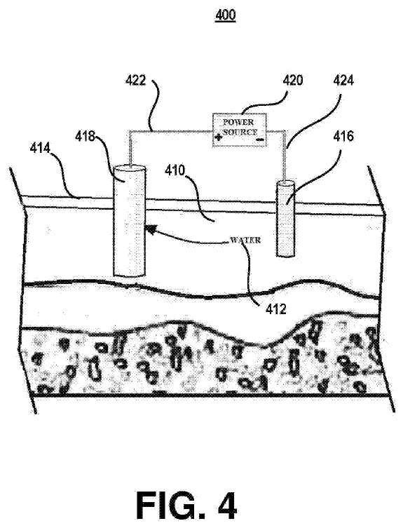

Referring now to FIG. 4 with continuing reference to the foregoing figures, there is shown another embodiment of an electrochemical treatment system, generally designated by the numeral 400, for treating soil and/or other growth media, generally designated by the numeral 410. The system 400 is particularly adapted for moving water 412 upwardly against the direction of gravity flow on a land gradient 414 because water molecules are polar molecules that can be driven by electrical fields that are generated through electrochemical cells.

The need to utilize the system 400 to move water against the direction of gravity flow derives from the fact that gravity makes water run downhill. The system 400 can be utilized in certain agricultural applications because farming communities in hilly or in mountainous regions have difficulty accessing sufficient water. The system 400 can replace hydraulic ramp pumping devices, which must be located close to free-flowing water.

Like the embodiments shown in FIGS. 1-3, the system 400 includes a high-performance alloy cathode 416, an oxidation resistant anode 418, a power supply 420, and a pair of leads 422-424. The high-performance alloy cathode 416, the oxidation resistant anode 418, the power supply 420, and the pair of leads 422-424 function in the same manner as the high-performance alloy cathode 116, the oxidation resistant anode 118, the power supply 120, and the pair of leads 122-124 shown in FIG. 1, the high-performance alloy cathode 216, the oxidation resistant anode 218, the power supply 220, and the pair of leads 222-224 shown in FIG. 2, and/or the high-performance alloy cathode 318, the oxidation resistant anode 320, the power supply 322, and the pair of leads 324-326 shown in FIG. 3. The system 400 can be provided in an assembled form or as a kit for assembly.

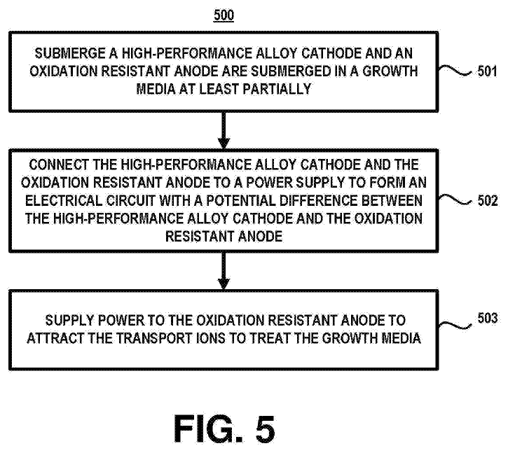

Referring now to FIG. 5 with continuing reference to the foregoing figures, an exemplary method, generally designated with the numeral 500, for treating soil and/or other growth media. The method 500 can be performed using the system 100 shown in FIG. 1, the system 200 shown in FIG. 2, the system 300 shown in FIG. 3 and/or the system 400 shown in FIG. 4.

At 501, a high-performance alloy cathode and an oxidation resistant anode is submerged in the growth media at least partially. In this exemplary embodiment, the high-performance alloy cathode can be the high-performance alloy cathode 116 shown in FIG. 1, the high-performance alloy cathode 216 shown in FIG. 2, the high-performance alloy cathode 318 shown in FIG. 3, and/or the high-performance alloy cathode 416 shown in FIG. 4.

The oxidation resistant anode can be the oxidation resistant anode 118 shown in FIG. 1, the oxidation resistant anode 218 shown in FIG. 2, the oxidation resistant anode 320 shown in FIG. 3, and/or the oxidation resistant anode 418 shown in FIG. 4. The growth media can be the soil 110 shown in FIG. 1, the soil 210 shown in FIG. 2, the soil 310 shown in FIG. 3, and/or the soil 410 shown in FIG. 4.

At 502, the high-performance alloy cathode and the oxidation resistant anode is connected to the power supply to form an electrical circuit with a potential difference between the high-performance alloy cathode and the oxidation resistant anode. In this exemplary embodiment, the power supply can be the power supply 120 shown in FIG. 1, the power supply 220 shown in FIG. 2, the power supply 322 shown in FIG. 3, and/or the power supply 420 shown in FIG. 4.

At 503, power is supplied to the oxidation resistant anode to attract the transport ions to treat the growth media. In this exemplary embodiment, the transport ions can be the chlorine ions 112 shown in FIG. 1, the phosphate ions and/or nitrate ions 212 shown in FIG. 2, the ions within the contaminants 314 shown in FIG. 3, and/or the polarized water molecules 412 shown in FIG. 4.

### Supported Features and Embodiments

The detailed description provided above in connection with the appended drawings explicitly describes and supports various features of apparatus and methods for treating soil and other growth media. By way of illustration and not limitation, supported embodiments include an electrochemical treatment system comprising: an electrochemical cell, the electrochemical cell having a high-performance alloy cathode, an oxidation resistant anode, an electrolyte, and a power supply, wherein the electrolyte is contained within growth media containing an aqueous solution and a plurality of transport ions therein, wherein the high-performance alloy cathode and the oxidation resistant anode are submerged in the growth media at least partially, and wherein the power supply provides power to the oxidation resistant anode to attract the plurality of transport ions to treat the growth media.

Supported embodiments include the foregoing electrochemical treatment system, wherein the oxidation resistant anode includes materials selected from the group consisting of graphite and noble metal alloys.

Supported embodiments include any of the foregoing electrochemical treatment systems, wherein the noble metals alloys include alloys selected from the group consisting of gold, platinum, silver, palladium, iridium, rhodium, and ruthenium.

Supported embodiments include any of the foregoing electrochemical treatment systems, wherein the noble metal alloys include metals that have filled electronic d-bands.

Supported embodiments include any of the foregoing electrochemical treatment systems, wherein the high-performance alloy cathode includes metal alloys selected from the group consisting of nickel alloys and iron alloys.

Supported embodiments include any of the foregoing electrochemical treatment systems, wherein the high-performance alloy structure includes stainless steel.

Supported embodiments include any of the foregoing electrochemical treatment systems, wherein the transport ions are selected from the group consisting of chlorine ions, water ions, phosphate ions, and nitrate ions.

Supported embodiments include any of the foregoing electrochemical treatment systems, wherein growth media includes landfill material and the transport ions include contaminants from the landfill material.

Supported embodiments include any of the foregoing electrochemical treatment systems, wherein the transport ions include heavy metal ions.

Supported embodiments include a kit, a method, an apparatus, and/or means for implementing any of the foregoing electrochemical treatment systems or a portion thereof.

Supported embodiments include a method for treating a growth media containing an aqueous solution and a plurality of transport ions therein, the method comprising: submerging a high-performance alloy cathode and an oxidation resistant anode in the growth media at least partially, connecting the high-performance alloy cathode and the oxidation resistant anode to the power supply to form an electrical circuit with a potential difference between the high-performance alloy cathode and the oxidation resistant anode, and supplying power to the oxidation resistant anode to attract the transport ions to treat the growth media.

Supported embodiments include the foregoing method, wherein the oxidation resistant anode includes materials selected from the group consisting of graphite and noble metal alloys.

Supported embodiments include any of the foregoing methods, wherein the noble metals alloys include alloys selected from the group consisting of gold, platinum, silver, palladium, iridium, rhodium, and ruthenium.

Supported embodiments include any of the foregoing methods, wherein the noble metal alloys include metals that have filled electronic d-bands.

Supported embodiments include any of the foregoing methods, wherein the high-performance alloy cathode includes metal alloys selected from the group consisting of nickel alloys and iron alloys.

Supported embodiments include any of the foregoing methods, wherein the high-performance alloy structure includes stainless steel.

Supported embodiments include any of the foregoing methods, wherein the transport ions are selected from the group consisting of chlorine ions, water ions, phosphate ions, and nitrate ions.

Supported embodiments include any of the foregoing methods, wherein growth media includes landfill material and the transport ions include contaminants from the landfill material.

Supported embodiments include any of the foregoing methods, wherein the transport ions include heavy metal ions.

Supported embodiments include any of the foregoing methods, further comprising: inserting the high-performance alloy cathode and the oxidation resistant anode are submerged in the growth media at least partially.

Supported embodiments include a system, a kit, an apparatus, and/or means for implementing any of the foregoing methods or a portion thereof.

Supported embodiments include a kit for treating growth media having an electrolyte with a plurality of transport ions and an aqueous solution contained therein, the kit comprising: a high-performance alloy cathode for inserting into the growth media at least partially, an oxidation resistant anode for inserting into the growth media, at least partially, at a predetermined distance from the high-performance alloy cathode, and a power supply for providing power to the oxidation resistant anode to attract the plurality of transport ions to treat the growth media.

Supported embodiments include the foregoing kit, wherein the oxidation resistant anode includes materials selected from the group consisting of graphite and noble metal alloys.

Supported embodiments include any of the foregoing kits, wherein the noble metals alloys include alloys selected from the group consisting of gold, platinum, silver, palladium, iridium, rhodium, and ruthenium.

Supported embodiments include any of the foregoing kits, wherein the noble metal alloys include metals that have filled electronic d-bands.

Supported embodiments include any of the foregoing kits, wherein the high-performance alloy cathode includes metal alloys selected from the group consisting of nickel alloys and iron alloys.

Supported embodiments include any of the foregoing kits, wherein the high-performance alloy structure includes stainless steel.

Supported embodiments include an apparatus, a method, a system, and/or means for implementing any of the foregoing kits or a portion thereof.

Supported embodiments can provide various attendant and/or technical advantages in terms of removing chlorides and other similar contaminants from soil and/or growth media.

Supported embodiments improve the efficiency of phosphate-based and/or nitrate-based fertilizers.

Supported embodiments can decontaminate soil and/or growth media that include landfill material.

Supported embodiments can move groundwater from lower elevations to higher elevations efficiently.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

1. An electrochemical treatment system comprising:
an electrochemical cell, the electrochemical cell having a high-performance alloy cathode, an oxidation resistant anode, an electrolyte, and a power supply,
wherein the electrolyte is contained within growth media containing an aqueous solution and a plurality of transport ions therein,
wherein the high-performance alloy cathode and the oxidation resistant anode are submerged in the growth media at least partially, and
wherein the power supply provides power to the oxidation resistant anode to attract the plurality of transport ions to treat the growth media.

2. The electrochemical treatment system of claim 1, wherein the oxidation resistant anode includes materials selected from the group consisting of graphite and noble metal alloys.

3. The electrochemical treatment system of claim 2, wherein the noble metals alloys include alloys selected from the group consisting of gold, platinum, silver, palladium, iridium, rhodium, and ruthenium.

4. The electrochemical treatment system of claim 2, wherein the noble metal alloys include metals that have filled electronic d-bands.

5. The electrochemical treatment system of claim 1, wherein the high-performance alloy cathode includes metal alloys selected from the group consisting of nickel alloys and iron alloys.

6. The electrochemical treatment system of claim 6, wherein the high-performance alloy structure includes stainless steel.

7. The electrochemical treatment system of claim 1, wherein the transport ions are selected from the group consisting of chlorine ions, water ions, phosphate ions, and nitrate ions.

8. The electrochemical treatment system of claim 1, wherein growth media includes landfill material and the transport ions include contaminants from the landfill material.

9. The electrochemical treatment system of claim 8, wherein the transport ions include heavy metal ions.

10. A method for treating a growth media containing an aqueous solution and a plurality of transport ions therein, the method comprising:
submerging a high-performance alloy cathode and an oxidation resistant anode in the growth media at least partially,
connecting the high-performance alloy cathode and the oxidation resistant anode to the power supply to form an electrical circuit with a potential difference between the high-performance alloy cathode and the oxidation resistant anode, and
supplying power to the oxidation resistant anode to attract the transport ions to treat the growth media.

11. The method of claim 10, wherein the oxidation resistant anode includes materials selected from the group consisting of graphite and noble metal alloys.

12. The method of claim 11, wherein the noble metals alloys include alloys selected from the group consisting of gold, platinum, silver, palladium, iridium, rhodium, and ruthenium.

13. The method of claim 11, wherein the noble metal alloys include metals that have filled electronic d-bands.

14. The method of claim 10, wherein the high-performance alloy cathode includes metal alloys selected from the group consisting of nickel alloys and iron alloys.

15. The method of claim 14, wherein the high-performance alloy structure includes stainless steel.

16. The method of claim 10, wherein the transport ions are selected from the group consisting of chlorine ions, water ions, phosphate ions, and nitrate ions.

17. The method of claim 10, wherein growth media includes landfill material and the transport ions include contaminants from the landfill material.

18. The method of claim 17, wherein the transport ions include heavy metal ions.

19. The method of claim 10, further comprising:
inserting the high-performance alloy cathode and the oxidation resistant anode are submerged in the growth media at least partially.

20. A kit for treating growth media having an electrolyte with a plurality of transport ions and an aqueous solution contained therein, the kit comprising:
a high-performance alloy cathode for inserting into the growth media at least partially,
an oxidation resistant anode for inserting into the growth media, at least partially, at a predetermined distance from the high-performance alloy cathode, and
a power supply for providing power to the oxidation resistant anode to attract the plurality of transport ions to treat the growth media.
